(19) United States
(12) Patent Application Publication
(10) Pub. No.: US 2009/0138468 A1
(43) Pub. Date: May 28, 2009

(54) 3D MODEL RETRIEVAL METHOD AND SYSTEM

(75) Inventor: Tsuneya KURIHARA, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: HITACHI, LTD.

(21) Appl. No.: 12/323,494

(22) Filed: Nov. 26, 2008

(30) Foreign Application Priority Data
Nov. 27, 2007 (JP) 2007-305938

(51) Int. Cl. G06F 7/06; G06F 17/30

(52) U.S. Cl. 707/5; 707/E17.014

(57) ABSTRACT

The present invention provides a 3D model retrieval system designed to extract feature vectors of 3D models to retrieve a similar model. Image feature vectors are extracted by subjecting target 3D models to rendering from various directions by using a random rotation generator and a 2D image generator. Then, the image feature vectors are registered in an image feature vectors database. Image feature vectors are extracted by subjecting a query 3D model to rendering from various directions by using another random rotation generator and another 2D image generator. The image feature vectors are compared to the contents of the image feature vectors database, thereby retrieving a 3D model.

### CLAIM OF PRIORITY

The present application claims priority from Japanese patent allocation JP 2007-305938 filed on Nov. 27, 2007, the content of which is hereby incorporated by reference into this application.

### BACKGROUND OF THE INVENTION

1. Field of the Invention

The present invention relates to a method and system for retrieving a 3D model.

2. Description of the Related Art

Recently, advances in computers and networks have been bringing 3D models into use in various scenes. There are a steadily increasing number of 3D model data items to be dealt with, and, in turn, there is a growing demand for efficient management of 3D model data or high-efficiency retrieval of a user-desired shape. Thus, there have been proposals of various methods pertaining to a 3D model retrieval method. As the 3D model retrieval method, there has been proposals of retrieval methods that involve generating 2D images from a 3D shape and calculating feature vectors from the 2D images.

### SUMMARY OF THE INVENTION

However, 3D model retrieval using 2D images has a problem of possibly making an incorrect comparison between two 3D models targeted for determination of the distance (or dissimilarity) therebetween, if the 3D models are in misaligned orientations. In Japanese Patent Application Publication No. 2006-277166, a front view, a top view and a side view are used for retrieval. However, the display of the front, top and side views for any given 3D model corresponds to the provision of three principal axes for the 3D model, which is a difficult thing to do, as likewise described in “J. W. H. Tangelder, R. C. Veltkamp: A survey of content based 3D shape retrieval methods, Proceedings of the Shape Modeling Applications, 2004, pp. 145-156”. In Japanese Patent Application Publication No. 2007-140810, for determination of the three principal axes, a primary axis is set in the direction of the longest dimension of a shape. However, the problem of an error occurring arises with a complex 3D shape, as previously mentioned.

In order to avoid the above problem of involving alignment of the orientations of models, “D.-Y. Chen, X.-P. Tian, Y.-T. Shen, and M. Ouhyoung: On visual similarity based 3D model retrieval. Computer Graphics Forum (EG 2003 Proceedings), 22(3), 2003” (referred to as Non-patent Document 2, below) proposes the approach of generating images for a 3D model as viewed in ten predetermined directions and using these images for 3D model retrieval. This approach involves calculating image feature vectors from silhouette images obtained from ten view points arranged around the 3D model. The distance between the images is calculated using 60 possible combinations for adaptation to the degree of freedom of rotation of the model. Further, ten groups each consisting of ten view points of subtly varying angles are formed for distance calculations independent of the rotation of the shape model. Thus, calculations for determination of the distance between 3D models require 5460 collations of multidimensional feature vectors for determination of a minimum distance. This leads to the problem of involving enormous amounts of calculations.

The present invention has been made in consideration of the above-described problems inherent in the related art. An object of the present invention is to provide a 3D model retrieval method capable of achieving high-accuracy retrieval by a small amount of calculations for determination of the distance (or dissimilarity) between 3D models, even if the 3D models are in misaligned orientations.

In order to attain the above object, a 3D model retrieval system according to the present invention rotates retrieval-target 3D models by use of random numbers and thereby generates 2D images as viewed in plural directions, and extracts image feature vectors from the 2D images. Likewise, the retrieval system rotates a query 3D model by use of random numbers and thereby generates 2D images as viewed in plural directions, and extracts image feature vectors from the 2D images. The retrieval system performs 3D model retrieval using the extracted feature vectors of the retrieval-target 3D models and the extracted feature vectors of the query 3D model, and thereby retrieves a 3D model similar to the query 3D model.

According to the present invention, 2D images are generated by using random numbers. Accordingly, the distance between 3D models can be calculated, even if the retrieval-target 3D models are in misaligned orientations.

### BRIEF DESCRIPTION OF THE DRAWINGS

FIG. 1 is a block diagram showing an example of the configuration of a 3D model retrieval system according to the present invention.

FIG. 2 is a block diagram showing the internal configuration of a computer on which a 3D model retrieval method according to the present invention is implemented.

FIG. 3 is a flowchart of assistance in explaining a processing procedure performed by a registration part.

FIG. 4 is an illustration showing the result of a 2D image generation process.

FIG. 5 is a table of assistance in explaining data stored in an image feature vectors database 4.

FIG. 6 is a flowchart of assistance in explaining a processing procedure performed by a query part.

FIG. 7 is an illustration showing the result of the 2D image generation processing.

FIG. 8 is a table of assistance in explaining data stored in the image feature vectors database 4.

FIG. 9 is a flowchart of assistance in explaining a procedure of distance calculation.

FIG. 10 is an illustration of assistance in explaining the types of 2D image.

### DESCRIPTION OF THE PREFERRED EMBODIMENTS

Detailed description will be given below with reference to the drawings with regard to a preferred embodiment of the present invention.

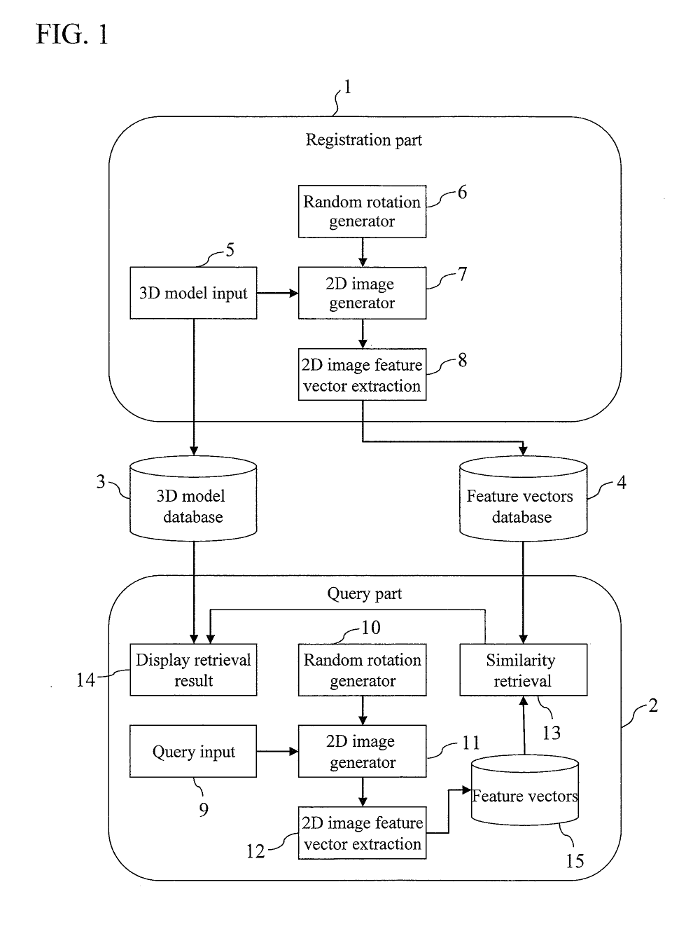

FIG. 1 is a block diagram showing an example of the configuration of a 3D model retrieval system according to the present invention. The retrieval system includes a registration part 1 and a query part 2. The registration part 1 is the part for registration of a 3D model targeted for retrieval, and receives input of 3D model data targeted for retrieval and registers the 3D model in a 3D model database 3. Further, the registration part 1 calculates feature vectors of the 3D model targeted for retrieval, and registers the feature vectors in a feature vectors database 4. Description will be given later with regard to details of the feature vectors of the 3D model. The query part 2 is the part for retrieval of a similar model and is connected to the 3D model database 3 and the feature vectors database 4. The query part 2 receives input of a similar model to a desired model for retrieval, retrieves the similar model by using the 3D model database 3 and the feature vectors database 4, and provides display of a retrieved result.

The registration part 1 includes a 3D model input 5, a random rotation generator 6, a 2D image generator 7, and a 2D image feature vectors extraction 8. The query part 2 includes a query input 9, a random rotation generator 10, a 2D image generator 11, a 2D image feature vectors extraction 12, a similarity retrieval 13, a display retrieval result 14, and feature vectors 15. Incidentally, the random rotation generator 6 of the registration part 1 has the same function as the random rotation generator 10 of the quarry part 2. Also, the 2D image generator 7 of the registration part 1 has the same function as the 2D image generator 11 of the query part 2, and the 2D image feature vectors extraction 8 of the registration part 1 has the same function as the 2D image feature vectors extraction 12 of the quarry query 2.

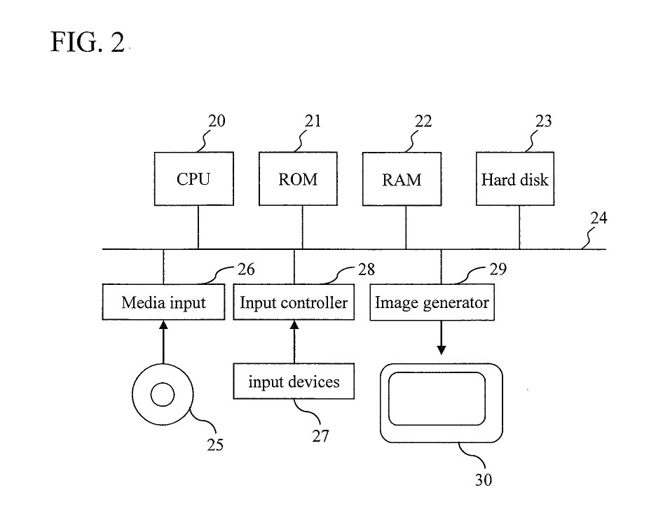

FIG. 2 is a block circuit diagram showing the internal configuration of a computer on which a 3D model retrieval method according to the present invention is implemented. In FIG. 2, a data bus 24 has connections to a CPU (central processing unit) 20, a ROM (read only memory) 21, a RAM (random access memory) 22, a hard disk 23, a media input 26, an input controller 28, and an image generator 29. A program for execution of the 3D model retrieval method according to the present invention is loaded from a recording medium 25 via the media input 26 into the RAM 22 to be stored therein. Alternatively, the 3D model retrieval program may be loaded from the hard disk 23 into the RAM 22 to be stored therein. User-entered information from input devices 27 is transmitted via the input controller 28 to the CPU 20. The image generator 29 creates image information, based on the results of 3D model retrieval, and the image information is displayed on a display device 30.

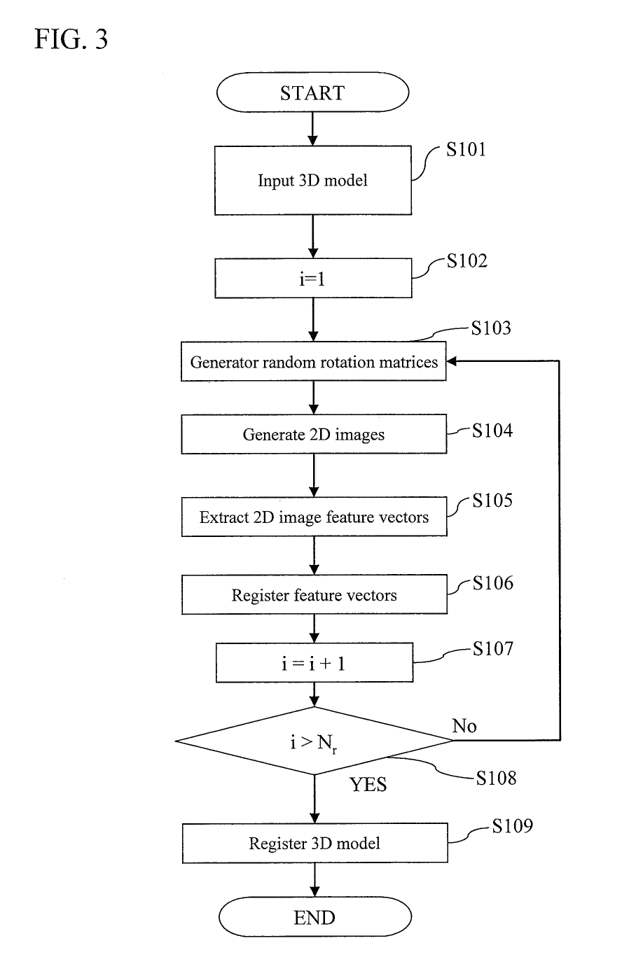

Description will now be given of operation of the system shown in FIG. 1 with reference to a flowchart. FIG. 3 shows a flowchart of assistance in explaining a processing procedure for a 3D model targeted for retrieval, which is executed by the registration part 1. First, a 3D model to be registered is input by the 3D model input 5 (step S101). At this time, the 3D model is moved to the origin, and further, its size is normalized. Then, “1” is assigned to i, which is a counter for the number of processes performed for 2D image generation (step S102). The random rotation generator 6 generates a random rotation matrix (step S103). The 2D image generator 7 generates a 2D image for the 3D model input from the 3D model input 5 by using the random rotation matrix (step S104). The 2D image feature vectors extraction 8 extracts image feature vectors from the generated 2D image (step S105). The extracted 2D image feature vectors are registered in the feature vectors database 4 (step S106). Then, the counter i for the number of processes for 2D image generation is incremented (step S107). A comparison is performed between the counter i and the preset number Nᵣ of 2D image generations (step S108), and, if the counter i is equal to or less than Nᵣ, the processing returns to step S103 to continue 2D image generation and 2D image feature vectors extraction. If the counter i is more than Nᵣ, the image feature vectors extraction is brought to an end, and the processing goes to the next step (step S108). Then, the input 3D model is registered in the 3D model database 3 (step S109).

With the above processing, one 3D model is registered as a retrieval target in the database. To register plural 3D models, the above processing is executed for each 3D model to be registered.

Nᵣ 2D image feature vectors are extracted for each 3D model and are stored in the feature vectors database 4. The number Nᵣ of 2D image generations is the user-preset number. Setting the large Nᵣ value increases retrieval accuracy but also increases retrieval time. The Nᵣ value is any given value, and may be set to, for example, 64 (Nᵣ=64).

The 3D model input processing performed at step S101 moves the 3D model to the origin and normalizes its size, as mentioned above. This processing is accomplished by determining a bounding box from the 3D model and moving the 3D model so that the center of the bounding box coincides with the origin. Size normalization is accomplished for example by increasing or reducing the length of the longest one of three axes of the bounding box so as to adjust the length to a given size (e.g., 1).

The random rotation matrix generation processing performed at step S103 generates rotation matrices in random directions by using random numbers. Details of this processing are described for instance in “James Arvo: Fast random rotation matrices. In David Kirk, editor, Graphics Gems III, pages 117-120. Academic Press, 1992.”

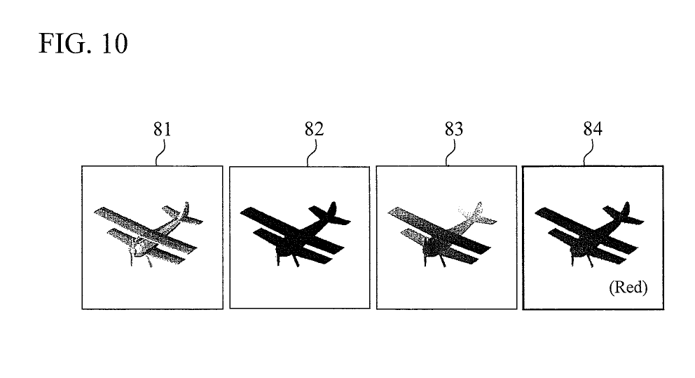

The 2D image generation processing performed at step S104 performs rendering using a graphic library function such as OpenGL or DirectX. Here, a rendering image is of three types: (1) a shaded image assuming a light source model, (2) a silhouette image obtained by painting the 3D model with black, and (3) a depth image obtained by representing the depth of the 3D model by greyscale, any one of which is selectable. FIG. 10 shows examples of the shaded image, the silhouette image and the depth image. In FIG. 10, reference numeral 81 denotes the shaded image; 82, the silhouette image; and 83, the depth image.

The use of the graphic library such as OpenGL or DirectX enables high-speed rendering of a polygonal shape or a parametric surface.

Generation of the silhouette image 82 can be accomplished by performing rendering by setting a background and an object to white and black, respectively.

Generation of the depth image 83 can be accomplished by performing rendering using a Z buffer function of OpenGL, then reading Z buffer information, and generating a greyscale image in accordance with the value of Z buffer. In an example of 83 shown in FIG. 10, the depth image 83 is assigned white at a part close to the view point in the depth Z, and is assigned black at a part far away from the view point in the depth Z.

Methods for generating the shaded image 81 assuming a light source model include various rendering methods. The position of the light source, the color or intensity of the light source, the type of light source, or the like may be changed. Also, a color, a texture, and a reflection attribute may be set for the shape model.

For the similar 3D object retrieval, it is required that rendering be performed under the same condition, using all targets and a query. Also, it is convenient if rendering is performed as fast as possible. This is accomplished for example by using a parallel light source in a direction from the position of a camera to the center of an object as the light source. Also, Lambert model assuming that diffusion reflection alone occurs is used as the reflection attribute.

Incidentally, for the 2D image generation processing, any one of the above three types of image generation methods may be selected, or plural types of image generation methods, such as the shaded image and the depth image, may be used in combination. For generation of plural types of images, the same type of image is used to calculate the distance between images, which calculations will be described later.

The above method performs rendering for shaded image generation while ignoring information such as the color or texture inherent in the 3D model. In this case, 3D model retrieval is possible using shape information alone while ignoring color pattern texture information.

On the other hand, it may be desired that the information such as the color or texture inherent in the 3D model be used for 3D model retrieval. In this case, rendering for the shaded image generation may be performed using the information such as the color or texture inherent in the 3D model. In such a case, retrieval for the 3D model retrieval using the color and texture information becomes possible. In FIG. 10, an example of a colored image is shown as indicated by 84. The image 84 is a red image.

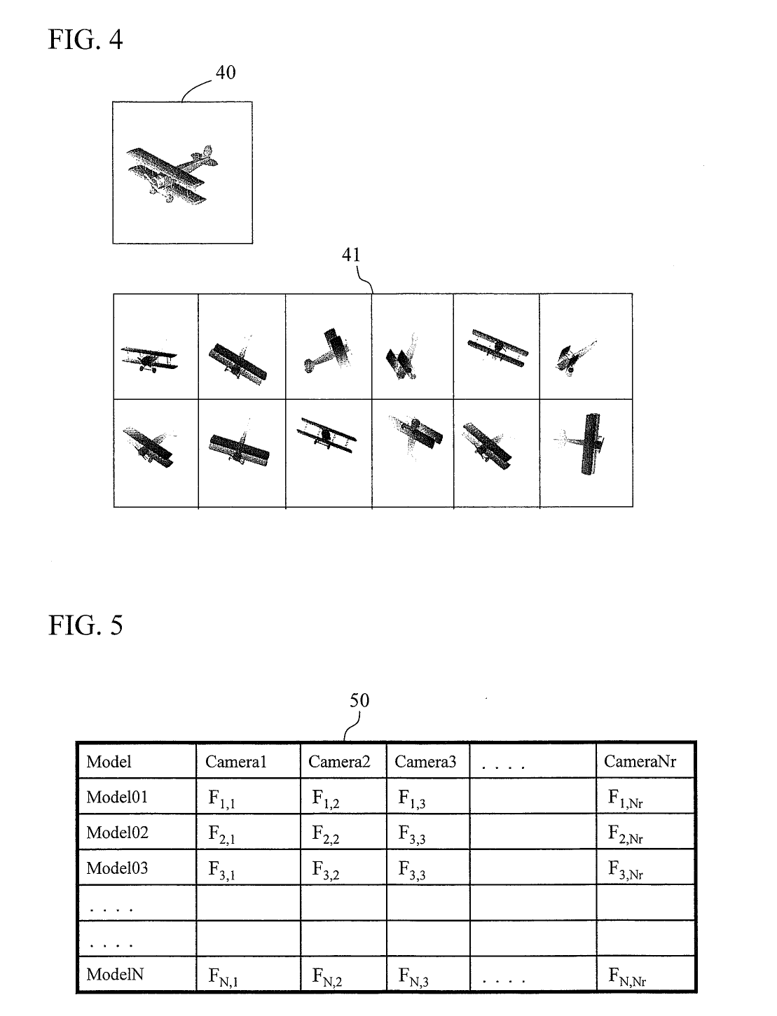

FIG. 4 is an illustration showing an example of the result of the 2D image generation processing performed at step S104. A 3D model indicated by 40 is rotated in a random rotation matrix, and Nᵣ depth images 41 (Nᵣ₌12, as employed in FIG. 4) are generated.

The 2D image feature vector extraction processing performed at step S105 generates image feature vectors from the 2D image. There have been proposals of various types of image feature vectors; however, in the present invention, any type of feature vector may be used. In the embodiment, a gray level histogram feature vector and an edge feature vector described in Japanese Patent Application Publication No. 2000-29885 are used. The gray level histogram feature vector is obtained by dividing an image into lattices, and using multidimensional vectors created from the gray level histograms of the divided regions as image feature vectors. The edge feature vector is determined in the following manner. First, plural characteristic edge patterns are preset. Then, an image is divided into lattices, and the number of edge patterns contained in each region is counted. A histogram is generated based on the number of edge patterns, the histograms thus generated are used as a multidimensional vector, to thereby create image feature vectors.

At step S106, the image feature vectors are stored in the feature vectors database 4. FIG. 5 shows an example of data stored in the feature vectors database 4. Here, N represents the number of 3D models registered as targets. Nᵣ feature vector vectors are extracted for each model to generate Nᵣ images for each model. In FIG. 5, F_{i,j} represents the feature vector of the camera j of the model i. Incidentally, different rotations may be used for each model i as the camera j, or the same rotation may be used for each model i.

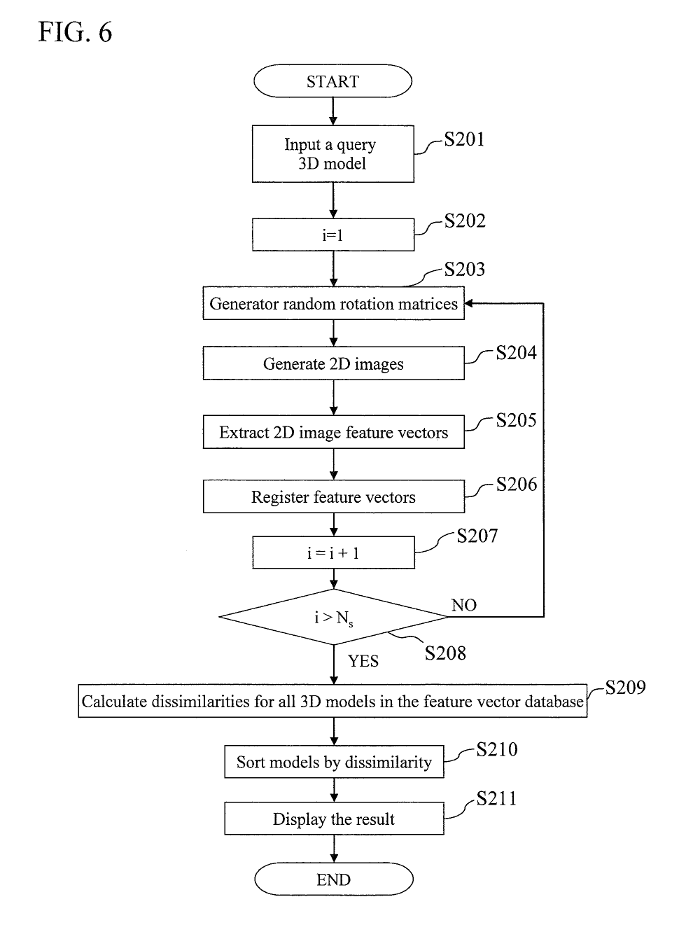

FIG. 6 is a flowchart of assistance in explaining a processing procedure in the query part 2. The query input 9 specifies a 3D model to be a query (step S201). At this time, the 3D model is moved to the origin, and further, its size is normalized. Then, “1” is assigned to i, which is the counter for the number of processes for 2D image generation (step S202). The random rotation generator 10 generates a random rotation matrix (step S203). The 2D image generator 11 receives input of a query model from the query input 9, and generates a 2D image by using the random rotation matrix (step S204). The 2D image feature vector extraction 12 extracts image feature vectors from the generated 2D image (step S205). The extracted 2D image feature vectors are registered in the feature vectors 15 (step S206). Then, the counter i for the number of processes for 2D image generation is incremented (step S207). A comparison is performed between the counter i and the preset number Nₛ of 2D image generations, and, if the counter i is equal to or less than Nₛ, the processing returns to step S203 to continue 2D image generation and 2D image feature vector extraction (step S208). If the counter i is more than Nₛ, the image feature vector extraction is brought to an end, and the processing goes to the next step (step S208). Then, the distance to all models in the database are calculated using the feature vector 15 of the query model and the feature vectors database 4 (step S209). Description will be given later with regard to details of this processing. The target models are sorted by the calculated distance (step S210). The models sorted in distance order are displayed on the display 30 (step S211). The above processing realizes 3D model retrieval.

The number Nₛ of 2D image generations is the user-preset number. Setting the large Nₛ value increases retrieval accuracy but also increases retrieval time. The Nₛ value is any given value, and may be set to, for example, 16 (Nₛ=16).

The 3D model input process at step S201 is based on the processing executed at step S101 by the registration part 1, and moves the 3D model from the bounding box information to the origin and normalizes its size, as mentioned above. The random rotation matrix generation processing performed at step S203 is the same as the processing performed at step S103 by the registration part 1. The 2D image generation processing performed at step S204 is the same as the processing performed at step S104 by the registration part 1, and generates the image of the same type as the image generated by the 2D image generation processing performed at step S104.

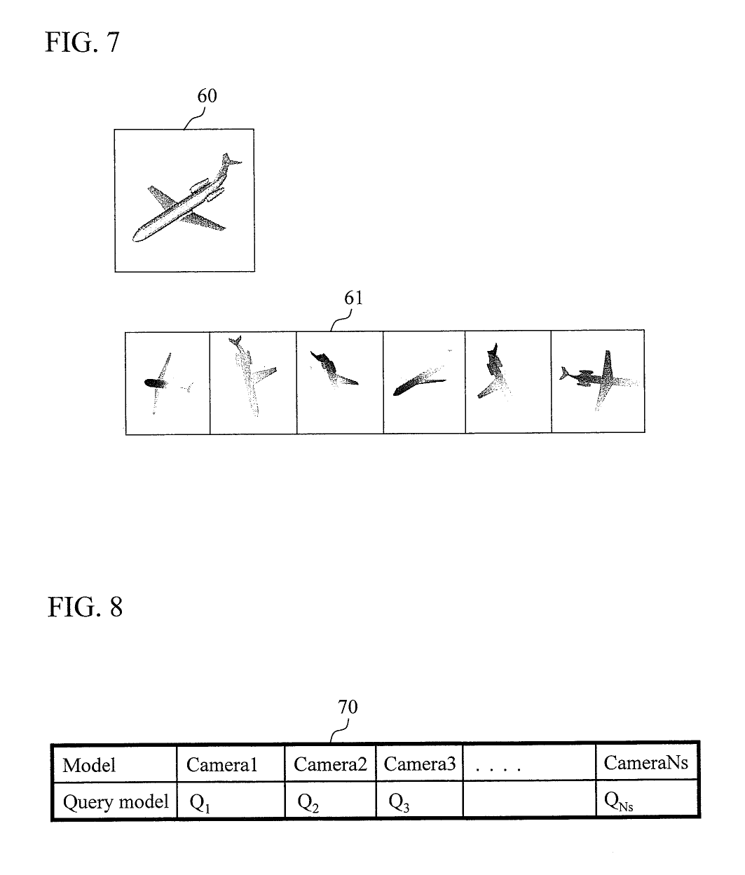

FIG. 7 is an illustration showing an example of the result of the 2D image generation processing performed at step S204. A 3D model indicated by 60 is rotated in a random rotation matrix, and Nₛ depth images 41 (Nₛ=6, as employed in FIG. 7) are generated.

The 2D image feature vector extraction processing performed at step S205 is the same as the processing performed at step S105 by the registration part 1. At step S206, the image feature vectors of the query model are stored in the feature vectors 15. FIG. 8 shows an example of data stored in the feature vectors database 4. Nₛ feature vectors are extracted to generate Nₛ images for the query model. In FIG. 8, Qⱼ represents the feature vector of the camera j.

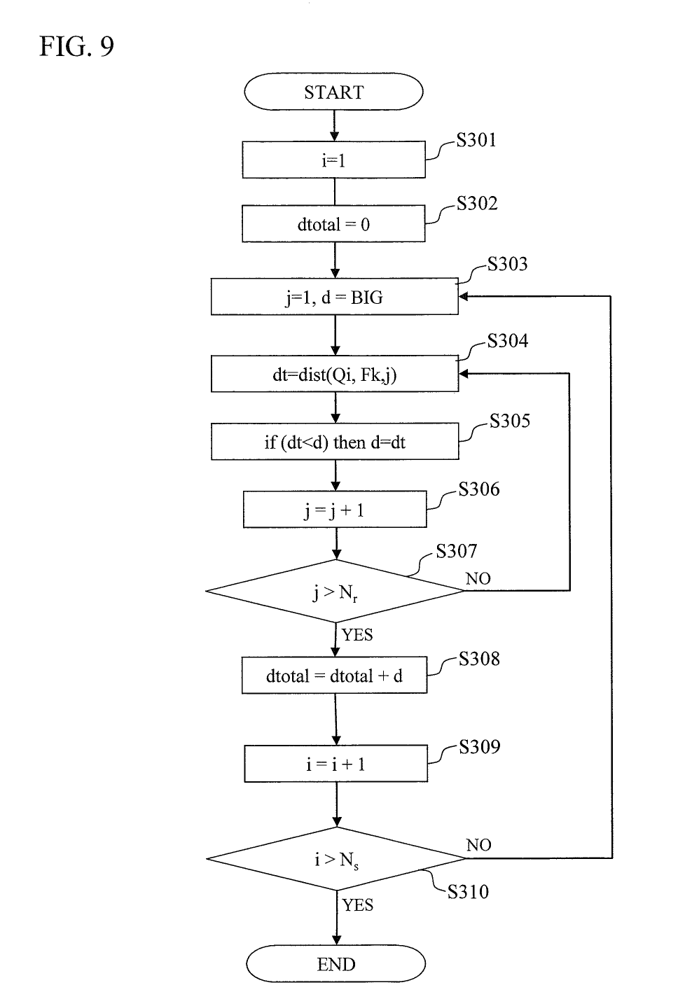

Description will now be given with regard to the details of the distance calculation performed at step S209 with reference to a flowchart of FIG. 9. Here, a method for calculating the distance between a retrieval-target model k and a query model is shown. The query model has Nₛ feature vectors Qᵢ (1≦i≦Nₛ), and the distance to the retrieval-target model k is calculated for the Nₛ feature vectors Qᵢ. The counter i for Nₛ times of distance calculations is initialized to 1 (step S301). Then, the distance dₜₒₜₐₗ between the retrieval-target model k and the query model is initialized to 0 (step S302). Calculations are performed to obtain the distance between the feature vectors Qᵢ of the query model and all feature vectors F_{k,j} (1≦j≦Nᵣ) of the retrieval-target model k are performed, and a minimum distance is set as the distance between Qᵢ and the retrieval-target model k. The counter j for this is initialized to 1, and further, a variable d for storage of the minimum distance is initialized to a sufficiently large number BIG (step S303). The distance between Qᵢ and F_{k,j} is calculated, and calculated results are stored as dt (step S304). If the newly calculated distance dt is less than the minimum distance d, dt is assigned to d so that the minimum distance d is updated (step S305). At step S306, the counter j is incremented. If the counter j is equal to or less than Nᵣ, the calculations are continued to be performed to obtain the minimum distance between Qᵢ and the target model k (step S307). If the counter i exceeds Nᵣ, the minimum distance of the feature vector between Qᵢ and the retrieval-target model k is stored as d. The distance d is added to the total distance dₜₒₜₐₗ between the models (step S308). The counter i is incremented (S309). If the counter i is equal to or less than Nₛ, the same distance calculation is performed for Qᵢ+1 (step S310). If the counter i exceeds Nₛ, dₜₒₜₐₗ is the distance between the query model and the retrieval-target model k to be determined.

Incidentally, the calculations for determination of the distance between the feature vector Qᵢ and the feature vector F_{k,j} performed at step S304 is accomplished by using the sum square of the distance between multidimensional vectors. Here, Manhattan distance may be used as the distance between the multidimensional vectors.

The calculations for determination of the distance between the query model and the retrieval-target model k are performed N times, where N represents the number of target models.

The above processing enables determining a 3D model similar to the query model from retrieval objects.

Incidentally, in the embodiment, a shaded image, a silhouette image, or a depth image may be used as the type of 2D image to be generated. Further, a combination of these may be used. If plural types of images are used in combination, distance calculations may be performed only for the same type of image at step S304.

Step S209 requires Nₛ×Nᵣ times of calculations for determination of the distance between the query 3D model and the retrieval-target 3D model k. Nₛ×Nᵣ×N times of distance calculations in total are required, where N represents the number of retrieval-target 3D models. According to verification experiments, it has been shown that the 3D model retrieval is possible with the Nₛ value being approximately 16 (Nₛ=16) and the Nᵣ value being approximately 64 (Nᵣ=64). In this instance, the number of distance calculations is 1024, and is reduced to ⅕ or less, as compared to 5460 calculations described in Non-patent Document 2. Further, according to retrieval tests, retrieved results are obtained with higher accuracy than the retrieval accuracy described in Non-patent Document 2.

Specifically, the retrieval tests have been performed using Princeton Shape Benchmark (abbreviated as PSB below) described in “Philip Shilane, Patrick Min, Michael Kazhdan, Thomas Funkhouser: The Princeton Shape Benchmark, Proc. International Conference on Shape Modeling and Applications 2004 (SMI '04), pp. 167-178, 2004.” 907 data was used for the PSB test. For the PSB, 92 categories are assigned. These categories were used to determine Nearest Neighbor (NN), R-Precision (1R), and 2R-Precision (2R). Here, NN, 1R and 2R are evaluation scales as given below. It is assumed that the models in the database are classified into categories Cᵢ (i=1, . . . , n). R-Precision is the percentage of correct models contained in higher-order retrieved results |Cᵢ|, if retrieval request is m ε Cᵢ. 2R-Precision is substantially the same as R-Precision, and is the percentage of correct models contained in higher-order retrieved results 2|Cᵢ|. Nearest Neighbor is the percentage of models in a desired category appearing in highest-order retrieved results. Performance described in Non-patent Document 2 is such that NN, 1R and 2R are 66.0%, 37.8% and 48.7%, respectively. In the embodiment, NN, 1R and 2R are 69.5%, 41.3% and 51.4%, respectively. As mentioned above, the present invention achieves higher retrieval accuracy than the method described in Non-patent Document 2. Further, the present invention is characterized by small amounts of calculations.

Further, the amount of calculations for retrieval according to the embodiment of the present invention can be reduced in the following manner. Mₛ image feature vectors (Mₛ<Nₛ) are selected from Nₛ image feature vectors extracted from the query model. For example, Nₛ is set to 16 (Nₛ=16), while Mₛ is set to 4 (Mₛ=4). Further, Mᵣ image feature vectors (Mᵣ<Nᵣ) are selected from Nᵣ image feature vectors of the retrieval-target model k. For example, Nᵣ is set equal to 64 (Nᵣ=64), while Mᵣ is set equal to 16 (Mᵣ=16). By performing the same processing as that performed at step S209, the approximate distance between the query model and the retrieval-target model is calculated from the selected Mₛ image feature vectors of the query model and the selected Mᵣ image feature vectors of the retrieval-target model k. This calculation is performed Mₛ×Mᵣ times. In the above instance, 64 calculations are performed. The models having the short approximate distance, that is, higher-order candidates for similar retrieval, alone are selected. The selection of the higher-order candidates may be accomplished by selecting a predetermined number of candidates in increasing order of approximate distance, or by selecting candidates having the approximate distance less than a predetermined threshold value. The distance calculation at step S209 is performed only for the selected 3D model, and thereby, less calculation time is required for similar retrieval.

Description will now be given with regard to advantageous effects of the embodiment. In the registration part 1, the random rotation generator 6 generates plural random rotation matrices, and uses these random rotation matrices to perform 2D image generation and feature vector extraction. In the query part 2, the random rotation generator 10 generates plural random rotation matrices, and uses these random rotation matrices to perform 2D image generation and feature vector extraction. Then, a comparison is performed between the above-mentioned feature vectors, thereby enabling similar retrieval even if the retrieval-target and query models are in misaligned orientations.

For the similar retrieval, only feature vectors extracted from 2D images generated by the 2D image generator 7 and by the 2D image generator 11 are used. Accordingly, the present invention is applicable to various 3D models such as a polygon, a freeform surface and voxels, provided that they are renderable 3D models.

### EXPLANATION OF REFERENCE NUMERALS

1 registration part
2 query part
3 3D model database
4 feature vectors database
5 3D model input
6 random rotation generator
7 2D image generator
8 2D image feature vector extraction
9 query input
10 random rotation generator
11 2D image generator
12 2D image feature vector extraction
13 similarity retrieval
14 display retrieval result
15 feature vectors

What is claimed is:

1. A 3D model retrieval system, comprising:
a first 2D image generator that generates 2D images for each of a plurality of retrieval-target 3D models as viewed in a plurality of directions, by rotating the plurality of retrieval-target 3D models by use of random numbers;
a first feature vector extraction that extracts image feature vectors from the 2D images generated by the first 2D image generator;
a second 2D image generator that generates 2D images for a query 3D model as viewed in a plurality of directions, by rotating the query 3D model by use of random numbers;
a second feature vector extraction that extracts image feature vectors from the 2D images generated by the second 2D image generator; and
a similarity retrieval that retrieves a 3D model similar to the query 3D model by calculating the distance between the query 3D model and each of the retrieval-target 3D models, using the feature vectors extracted by the first feature vector extraction and the feature vectors extracted by the second feature vector extraction.

2. The 3D model retrieval system according to claim 1, wherein the 2D images generated by the first 2D image generator and by the second 2D image generator are any one of or a combination of silhouette images, shaded images and depth images.

3. The 3D model retrieval system according to claim 1, wherein the 2D images generated by the first 2D image generator and by the second 2D image generator are shaded images having any one of or both of a color and a texture.

4. The 3D model retrieval system according to claim 1, wherein as the distance between the query 3D model and each of the retrieval-target 3D models, the similarity retrieval uses the sum of minimum distances between each of Nₛ image feature vectors extracted by the second feature vector extraction and Nᵣ image feature vectors extracted for each 3D model by the first feature vector extraction.

5. The 3D model retrieval system according to claim 4, wherein the similarity retrieval selects a plurality of image feature vectors from among the Nₛ image feature vectors and also selects a plurality of image feature vectors from among the Nᵣ image feature vectors, calculates the approximate distance between the query 3D model and each of the retrieval-target 3D models by using sets of the selected image feature vectors, and performs 3D model retrieval only on higher-order 3D models having the close approximate distance.
